(19) United States
(12) Patent Application Publication
(10) Pub. No.: US 2011/0143695 A1
(43) Pub. Date: Jun. 16, 2011

(54) SENSING APPARATUS, NETWORK SYSTEM AND CONTROLLING METHOD ON THE BASIS OF SATELLITE

(75) Inventors: Yong Min LEE, Daejeon (KR); Do Seob Ahn, Daejeon (KR); Ho Jin Lee, Daejeon (KR)

(73) Assignee: ELECTRONICS AND TELECOMMUNICATIONS RESEARCH, Daejeon-city (KR)

(21) Appl. No.: 12/829,858

(22) Filed: Jul. 2, 2010

(30) Foreign Application Priority Data
Dec. 15, 2009 (KR) 10-2009-0124984

(51) Int. Cl. H04B 1/034

(52) U.S. Cl. 455/98

(57) ABSTRACT

Disclosed is a sensing apparatus, a network system, and a controlling method on the basis of a satellite. A satellite-based sensing network system, comprising: a plurality of satellite transmitters that collect information on a peripheral environment and an operating state, and transmits it to peripheral satellites; a satellite wireless receiving/display device that directly receives and displays the information collected from the satellites; a ground control center that receives, stores, and analyzes the information collected from the satellites; and a management center that maintains and repairs the satellite transmitter based on the analyzed results.

### CROSS-REFERENCE TO RELATED APPLICATIONS

This application claims priority under 35 U.S.C. §119 to Korean Patent Application No. 10-2009-0124984, filed on Dec. 15, 2009, in the Korean Intellectual Property Office, the disclosure of which is incorporated herein by reference in its entirety.

### BACKGROUND OF THE INVENTION

1. Field of the Invention

The present invention relates to a sensing network, and more particularly, to a sensing apparatus, a network system, and a controlling method on the basis of a satellite that can transmit sensed information even in a shadow area of mobile telecommunication.

2. Description of the Related Art

Recently, a sensing network technology has been actively developed which can provide necessary information to anyone at any time and anywhere by building a sensing network for sensing more information from objects or the environment.

Further, the sensing network technology may be applied to various industries such as monitoring of weather, environment, buildings, aged facilities, fire, town, natural disaster, distribution state of products, quality measurement, water quality monitoring, and so on.

However, since the sensing network is based on local area communication, it requires a plurality of nodes in order to sense information in a wider area and transmit data therein as well as interworking with other networks.

For this reason, a recent sensing network interworks with various ubiquitous sensing network (USN) technology such as Zigbee, UWB, Bluetooth, etc., a wired network such as a modem, a mobile communication network such as code division multiple access (CDMA), and a radio Internet network such as Wibro.

However, as shown in FIG. 1, in the wired sensing network according to the related art, a section from a sensor to a user terminal should be connected by wires in order to transmit the sensed information to the user, such that much cost is consumed in configuring the network and the installation position is also limited.

Further, as shown in FIG. 2, the radio sensing network according to the related art has a limitation in performing the sensing function only in the service coverage of a radio mobile communication base station, such that it cannot collect the desired information in shadow areas such as mountain regions, remote areas, sea level, etc., that require the sensing network.

### SUMMARY OF THE INVENTION

In order to solve the above problems, it is an object of the present invention to provide a sensing apparatus, a sensing network system, and a controlling method on the basis of a satellite that can relay sensed information by using a satellite.

It is another object of the present invention to provide a sensing apparatus, a sensing network system, and a controlling method on the basis of a satellite that can monitor areas, which are difficult to directly access, by using a sensing network.

According to an aspect of the present invention, there is provided a satellite-based sensing network system including: a plurality of satellite transmitters that collect information on a peripheral environment and an operating state, and transmits it to peripheral satellites; a satellite wireless receiving/display device that directly receives and displays the information collected from the satellites; a ground control center that receives, stores, and analyzes the information collected from the satellites; and a management center that maintains and repairs the satellite transmitter based on the analyzed results.

According to another aspect of the present invention, there is provided a satellite-based sensing apparatus including: a sensor that collects information on a peripheral environment and an operating state; and a satellite transmitter that transmits the collected information to a satellite network.

According to another aspect of the present invention, there is provided a method for controlling a satellite-based sensing network, includes: collecting information on a peripheral environment sensed by a plurality of sensors and an operating state of the sensor; and transmitting the collected information to peripheral satellites according to a predetermined period.

According to another aspect of the present invention, there is provided a method for controlling a satellite-based sensing network including: receiving information on a peripheral environment sensed by a plurality of sensors through satellites and information on an operating state of the sensor; analyzing whether there is abnormal generation in the sensor or the peripheral environment by using the received information; and commanding predetermined action against the abnormal sensor or the abnormal peripheral environment.

According to the present invention, it can easily collect materials regarding areas, which are difficult to directly access, by using a sensing network and relay the sensed information through a stationary satellite, such that it can easily monitor areas which are difficult to use mobile communication and the wired network and if necessary, can immediately send out the observed materials to the whole country as a broadcast type in real time.

Further, according to the present invention, it can reduce the economic loss and protect the health of the people due to yellow dust, ozone, red tide, forest fire, etc., which is lethal when exposed daily, by widening the monitoring. And it can improve the leisure activity according to provide information such as the measurement of the pollution level of a public restroom, the weather information of tourist spots, etc., in real time.

### BRIEF DESCRIPTION OF THE DRAWINGS

FIG. 1 is a diagram showing a wired sensing network according to the related art;

FIG. 2 is a diagram showing a wireless sensing network according to the related art;

FIG. 3 is a configuration diagram showing a satellite-based sensing network system according to an exemplary embodiment of the present invention;

FIG. 4 is a configuration diagram showing the satellite-based sensing apparatus according to an exemplary embodiment of the present invention; and

FIG. 5 is a flow chart showing a method for controlling a satellite-based sensing network system according to an exemplary embodiment of the present invention.

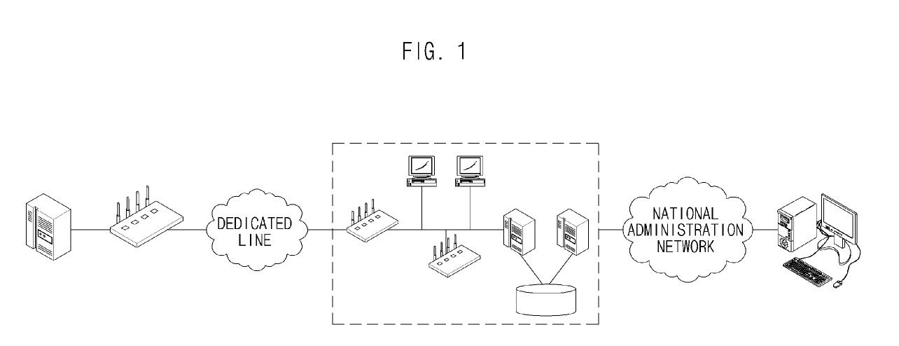

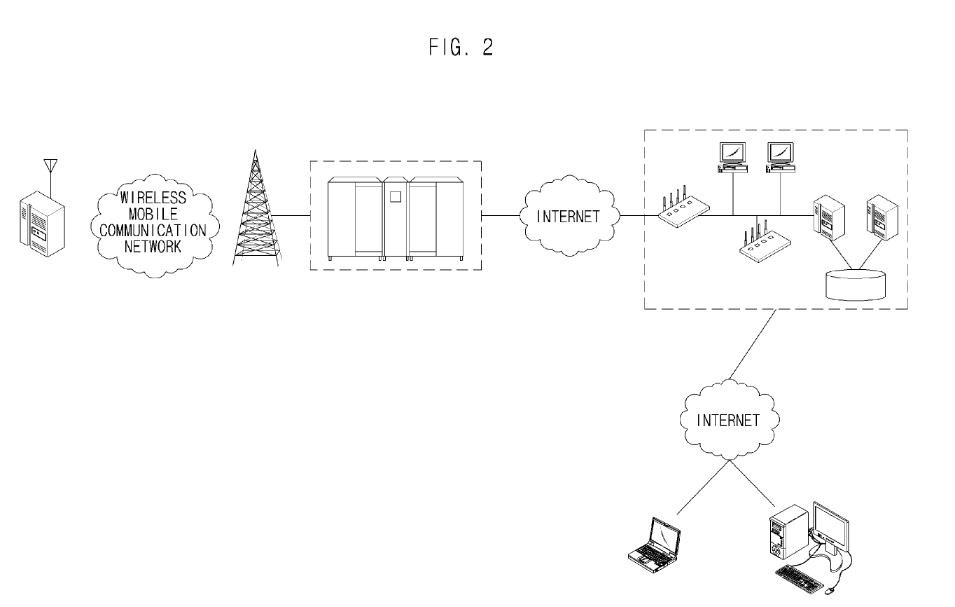

### DETAILED DESCRIPTION OF THE PREFERRED EMBODIMENTS

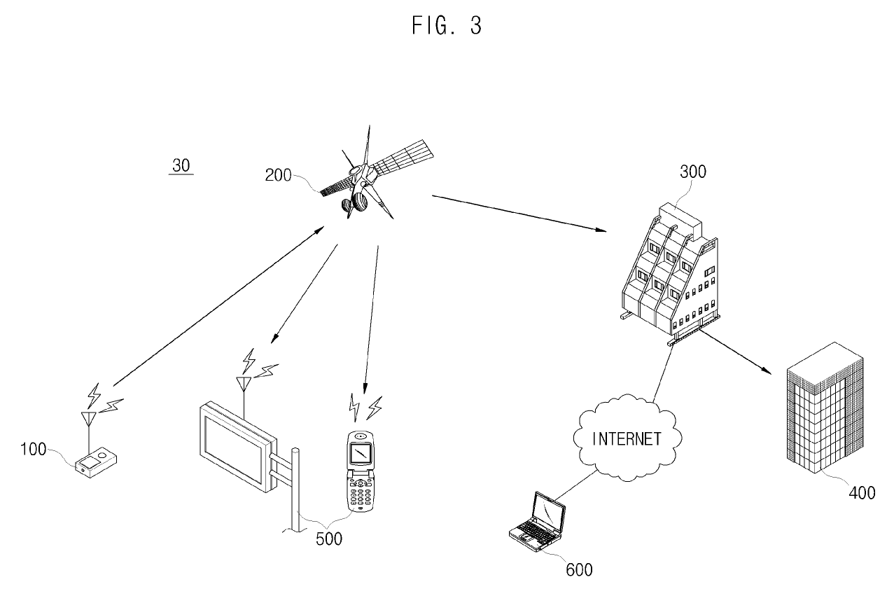

Hereinafter, a satellite-based sensing network system according to an exemplary embodiment of the present invention will be described with reference to FIG. 3. FIG. is a configuration diagram showing a satellite-based sensing network system according to an exemplary embodiment of the present invention.

As shown in FIG. 3, a satellite-based sensing network system 30 according to an exemplary embodiment of the present invention includes a plurality of satellite transmitters 100, a stationary satellite 200, a ground control center 300, and a management center 400.

The plurality of satellite transmitters 100 are each disposed in the environment to collect information on the peripheral environment and the operating state by using a sensor and transmit the information collected to the stationary satellite 200. Each of the satellite transmitters 100 may transmit image information having predetermined resolution as well as data information.

Each of the satellite transmitters 100 can collect information: weather information such as temperature, humidity, rainfall, snowfall, wind speed, etc., of mountain regions such as a national park, etc.; atmospheric information such as CO₂ (carbon dioxide), CO (carbon monoxide), sulfur oxide, nitrogen oxide, O₃, PM-10, direction of wind, wind speed, temperature, humidity, etc. in town; information on bridge management such as post crack, vibration, or overload of a bridge, etc.; information on environmental monitoring and facility management such as toxic gas, fine dust, aging of industrial facilities, etc.; information on water quality pollution management such as water temperature, pH concentration of a river, lake, sea, etc.; information on ground pollution of farmland, etc.; information on various fields such national defense, public health, prevention of disasters, security, etc.

In addition, each of the satellite transmitters 100 includes a solar cell and a small-sized storage battery to generate power, such that it can be easily installed at any location or any geographical landmark, thereby making it possible to transmit the collected information to the stationary satellite 200 at, for example, the small output of 0.2 W while securing line of sight with the stationary satellite 200.

Further, each of the satellite transmitters 100 may decode the collected information and transmit it. Herein, each of the satellite transmitters may periodically transmit the collected information according to a predetermined time interval in order to save power consumption.

The stationary satellite 200 is, for example, a satellite on a stationary orbit of an S or L band, receives small-output information transmitted from each of the satellite transmitters 100 by using a large-sized satellite antenna equipped in the stationary satellite 200, and amplifies the received information to retransmits to the ground control center 300 and a wireless terminal 500.

The wireless terminal 500 may be a portable mobile terminal, rooftop large-sized electric signs, and roadside electric signs and receive the retransmitted information by the stationary satellite 200 at a place where the line of sight with the stationary satellite 200 can be secured.

The ground control center 300 receives the retransmitted information from the stationary satellite 200 and stores and analyzes it.

Specifically, the ground control center 300 databases the peripheral information of each of the satellite transmitters 100 and stores it, or analyzes and monitors whether any problems occur in the peripheral environment. Further, if the ground control center 300 is determined that at least one of the satellite transmitters 100 should be repaired while monitoring, it informs the management center 400 of an abnormal occurrence of the satellite transmitters 100 and requests the repairs therefor.

In addition, the ground control center 300 may provide the received information to a user terminal 600 via an Internet network.

The ground control center 300 may display materials for the analysis results, or information through a display unit (not shown).

The management center 400 sends an employee to a spot where the state of the satellite transmitters 100 are abnormal according to the repair request of the ground control center 300 to repairs the abnormal satellite transmitter 100.

Meanwhile, the satellite-based sensing network system may include a receiver (not shown) that receives information collected by each sensor from the plurality of sensors included in the sensing network formed of a mobile communication network or a wired network. And the system 30 may provide the information received through the receiver (not shown) to the ground control center 300 or the wireless terminal 500 through each of the satellite transmitters 100 and the stationary satellite 200.

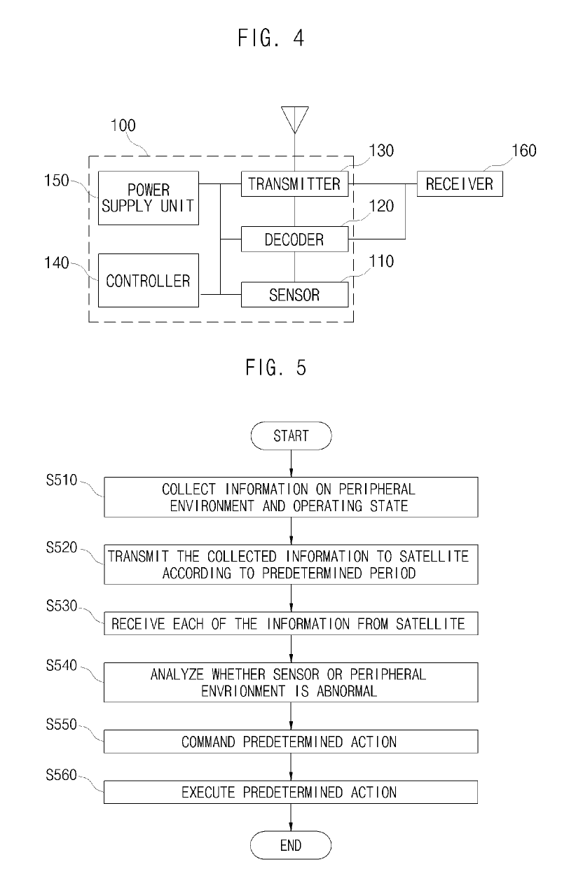

Hereinafter, the satellite-based sensing apparatus according to an exemplary embodiment of the present invention will be described with reference to FIG. 4. FIG. 4 is a configuration diagram showing the satellite-based sensing apparatus according to an exemplary embodiment of the present invention.

As shown in FIG. 4, the satellite-based sensing apparatus 100 according to the exemplary embodiment of the present invention includes a sensor 110, a decoder 120, a transmitter 130, a controller 140, and a power supply unit 150.

The sensor 110 collects the information on the peripheral environment to be sensed and the information on the operating state of the satellite-based sensing apparatus 100. The sensor 110 may be an image sensor, a temperature sensor, a humidity sensor, a wind direction sensor, a rainfall sensor, a heat sensor, a load sensor, a vibration sensor, an atmospheric sensor, a level sensor, etc.

The decoder 120 decodes each of the collected information according to the protocol of the satellite network, which are converted into the easy transmission and reception types.

The transmitter 130 amplifies each of the decoded information with a predetermined small output and then, transmits it at the predetermined time period.

The controller 140 controls the entire operations such as the transmission power, the decoding protocol, the transmission period, the power supply, the information collection, the operating state, etc.

The power supply unit 150 generates power using a solar cell and a small-sized storage battery, etc., and supplies the generated power to the sensor 110, the decoder 120, the transmitter 130, and the controller 140.

Meanwhile, the satellite-based sensing apparatus 100 further includes a receiver 160 that receives information collected by each sensor from the plurality of sensors included in the sensing network formed of a mobile communication network or a wired network, and may transmit the information received by the receiver 160 through the transmitter 130.

Hereinafter, a method for controlling a satellite-based sensing network according to an exemplary embodiment of the present invention will be described with reference to FIG. 5. FIG. 5 is a flow chart showing a method for controlling a satellite-based sensing network system according to an exemplary embodiment of the present invention. The satellite-based sensing apparatus 100 of FIG. 5 is assumed to be the satellite transmitter 100 of FIG. 3.

Referring to FIG. 5, the satellite-based sensing apparatus 100 collects the information on the sensed peripheral environment and the information on the operating state of each of the sensors collecting the information (S510).

Then, the satellite-based sensing apparatus 100 transmits each of the collected information to satellites according to the predetermined period (S520). At this time, satellite-based sensing apparatus 100 may decode the collected information and transmit it according to the predetermined period and may generate power from the solar power generation or the battery.

Next, the ground control center 300 or the wireless terminal 500 receives the information on the sensed peripheral environment transmitted and the operating state of each of the sensors through the satellite (S530).

The ground control center 300 analyzes whether there is abnormalities in each of the sensors or the peripheral environment by using the received information (S540).

And the ground control center 300 commands a predetermined action against each abnormal sensor or the abnormal peripheral environment (S550).

Thereafter, the management center 400 performs the predetermined action against the abnormal peripheral environment according to the command of the ground control center 300 (S560).

Meanwhile, the ground control center 300 may store each of the received information and each of the analyzing results, and provide them to the user terminal according to the user request.

Meanwhile, the wireless terminal 500 may provide various predetermined services using each of the received information through the satellites.

According to the present invention, it can easily collect materials regarding areas, which are difficult to directly access, by using a sensing network and relay the sensed information through a stationary satellite, such that it can easily monitor areas which are difficult to use mobile communication and the wired network and if necessary, can immediately send out the observed materials to the whole country as a broadcast type in real time.

Further, according to the present invention, it can reduce economic loss and protect the health of the people due to yellow dust, ozone, red tide, forest fire, etc., which may be lethal when exposed daily, by widening the monitoring. And it can improve the leisure activity according to provide information such as the measurement of the pollution level of the public restroom, the weather information of tourist spots, etc., in real time.

While configurations of certain embodiments have been described above with reference to the accompanying drawings, it is by way of example only. Those skilled in the art can make various modifications and changes within the technical spirit of the present invention. Accordingly, the actual technical protection scope of the present invention must be determined by the spirit of the appended claims.

What is claimed is:

1. A satellite-based sensing network system, comprising:
a plurality of satellite transmitters that collect information on a peripheral environment and an operating state, and transmits it to peripheral satellites;
a satellite wireless receiving/display device that directly receives and displays the information collected from the satellites;
a ground control center that receives, stores, and analyzes the information collected from the satellites; and
a management center that maintains and repairs the satellite transmitter based on the analyzed results.

2. The satellite-based sensing network system according to claim 1, wherein the ground control center provides the information to user terminal through an Internet network.

3. The satellite-based sensing network system according to claim 1, wherein the satellite transmitter collects the information associated with at least one of weather information, atmospheric information, bridge management, environment monitoring, facilities management, water quality pollution management, national defense, public health, prevention of disasters, and security.

4. The satellite-based sensing network system according to claim 1, wherein the satellite wireless receiving/display device receives the information from the satellites and includes wireless terminals in various types.

5. The satellite-based sensing network system according to claim 1, wherein the satellite transmitter generates power through a solar cell and a small-sized storage battery and is operated by the generated power.

6. The satellite-based sensing network system according to claim 1, wherein the satellite transmitter transmits the information to the satellites at predetermined time interval.

7. The satellite-based sensing network system according to claim 1, wherein the ground control center informs the management center that the peripheral environment is abnormal according to the analyzed results and the management center takes predetermined actions.

8. The satellite-based sensing network system according to claim 1, wherein the satellite transmitter includes a receiver receiving sensed information from a plurality of sensors through a mobile communication network or a wired network and transmits the sensed information received through the receiver to the satellite.

9. A satellite-based sensing apparatus, comprising:
a sensor that collects information on a peripheral environment and an operating state; and
a satellite transmitter that transmits the collected information to a satellite network.

10. The satellite-based sensing apparatus according to claim 9, wherein the satellite transmitter includes at least one of:
a decoder that decodes the information according to a protocol of the satellite network;
a transmitter that transmits the decoded information according to a predetermined time period; and
a receiver that receives information collected from the plurality of sensors of sensor network consisting of a mobile communication network or a wired network.

11. The satellite-based sensing apparatus according to claim 9, wherein the sensor includes at least one of an image sensor, a temperature sensor, a humidity sensor, a wind direction sensor, a rainfall sensor, a heat sensor, a load sensor, a vibration sensor, an atmospheric sensor, and a level sensor.

12. The satellite-based sensing apparatus according to claim 9, wherein the satellite network includes:
a stationary satellite that amplifies and retransmits the transmitted information;
a ground control center that receives and analyzes the retransmitted information; and
a management center that maintains and repairs the satellite-based sensing apparatus based on the analyzed results.

13. The satellite-based sensing apparatus according to claim 12, wherein the management center provides at least one of the analyzed results, the information, and the state of the satellite-based sensing apparatus to an user terminal.

14. A method for controlling a satellite-based sensing network, comprising:
collecting information on a peripheral environment sensed by a plurality of sensors and an operating state of the sensor; and
transmitting the collected information to peripheral satellites according to a predetermined period.

15. The method for controlling a satellite-based sensing network according to claim 14, further comprising at least one of:
decoding the collected information to transmit it to the satellites according to the predetermined period; and
generating power from solar power generation or a battery.

16. A method for controlling a satellite-based sensing network, comprising:
receiving information on a peripheral environment sensed by a plurality of sensors through satellites and information on an operating state of the sensor;
analyzing whether there is abnormal generation in the sensor or the peripheral environment by using the received information; and
commanding predetermined action against the abnormal sensor or the abnormal peripheral environment.

17. The method for controlling a satellite-based sensing network according to claim 16, further comprising taking predetermined action against the abnormal sensor or the abnormal peripheral environment according to the command.

18. The method for controlling a satellite-based sensing network according to claim 16, further comprising storing the received information and the analyzed results and providing them to a user terminal according to the user request.

19. The method for controlling a satellite-based sensing network according to claim 16, wherein the receiving includes providing the predetermined service using the information by an user wireless terminal.
